(19) United States
(12) Patent Application Publication
(10) Pub. No.: US 2011/0084606 A1
(43) Pub. Date: Apr. 14, 2011

(54) DEVICE FOR THE GENERATION OF MICROWAVES

(76) Inventors: Fredrik Olsson, Orebro (SE); Magnus Karlsson, Karlskoga (SE)

(21) Appl. No.: 12/991,298

(22) PCT Filed: Apr. 16, 2009
(86) PCT No.: PCT/SE09/00191

§ 371 Date: Dec. 10, 2010

(30) Foreign Application Priority Data
May 8, 2008 (SE) 0801029-0

(51) Int. Cl. H01J 23/36

(52) U.S. Cl. 315/39.53

(57) ABSTRACT

The invention relates to a device for the generation of microwaves, comprising a virtual cathode oscillator (1) in coaxial construction having an outer substantially cylindrical tube constituting a cathode (2) and connected to a transmission conductor (14) for feeding the cathode (2) with voltage pulses, as well as an inner substantially cylindrical tube, at least partially transparent for electrons, constituting an anode (3) and connected to a wave guide (13) for the discharge of microwave radiation generated by the formation of a virtual cathode (4) inside a region enclosed by the anode. The device comprises an electrically conductive structure in the form of a reflector (19) disposed adjacent to the anode (3). The cathode (2) comprises a substantially rotationally symmetric, electrically conductive body (15) having a cavity (16). By configuring the cavity (16) in the body (15) of the cathode with a first, lesser depth to that boundary surface (18) of the body which is directly in front of the peripheral part of the closure of the anode (3) against the cathode, and a second, greater depth to the boundary surface (17) of the body directly in front of the central part of the closure of the anode (3) against the cathode, a device for the generation of microwaves is produced, which has higher efficiency and high peak power.

The present invention relates to a device for the generation of microwaves, comprising a virtual cathode oscillator in coaxial construction having an outer substantially cylindrical tube constituting a cathode and connected to a transmission conductor for feeding the cathode with voltage pulses, as well as an inner substantially cylindrical tube, at least partially transparent for electrons, constituting an anode and connected to a wave guide for the discharge of microwave radiation generated by the formation of a virtual cathode inside a region enclosed by the anode, wherein an electrically conductive structure in the form of a reflector is disposed adjacent to the anode, and wherein the cathode comprises a substantially rotationally symmetric, electrically conductive body having a cavity.

A device according to the first paragraph is essentially previously known through “Microwave frequency determination mechanisms in a coaxial vircator”, Xupeng Chen et al, IEEE Transactions on Plasma Science, Vol. 32, Issue 5, Oct. 2004, pp. 1799-1804.

Microwave generators of this kind can, inter alia, be used to disable electronics by virtue of the high peak powers which can be briefly generated, or to generate pulses in systems which require high-power pulses for a short period.

A general problem with virtual cathode oscillators, often termed “vircators” in English, is that they are low in efficiency. There are therefore strong requirements to be able to improve the efficiency of the device. Moreover, it may be valuable to be able to increase the peak power and peak power efficiency of the device.

One object of the present invention is to provide a device for the generation of microwaves with improved efficiency. Another object is to improve the peak power of the device. Since the virtual cathode oscillator, the vircator, is primarily used to create high-power microwave radiation, the peak power efficiency, specifically, is a very important parameter.

The objects of the invention are achieved by a device for the generation of microwaves according to the first paragraph, characterized in that the cavity in the body of the cathode is configured with a first, lesser depth to that boundary surface of the body which is directly in front of the peripheral part of the closure of the anode against the cathode, and a second, greater depth to that boundary surface of the body which is directly in front of the central part of the closure of the anode against the cathode.

Through the introduction of a substantially rotationally symmetric, electrically conductive body with divergent depth relative to the closure of the anode against the cathode end, a favourable interaction between anode and cathode has been realized, resulting in increased efficiency and enhanced peak power efficiency. The increase in efficiency and peak power has been able to be verified by experiments and simulations.

Especially favourable improvements in efficiency and peak power are obtained if the body of the cathode is dimensioned with cavity and arrangement in relation to anode, reflectors and stop walls such that, according to a preferred embodiment, the closure of the device against the cathode is disposed at a distance to the boundary surface for the first, lesser depth of the body, which distance is substantially equal to an odd multiple of the quarter-wavelength for the microwaves to be generated. In particular, a compact construction is offered where the closure of the anode against the cathode is disposed at a distance to the boundary surface for the first, lesser depth of the body, which distance is substantially equal to a quarter-wavelength for the microwaves to be generated. By choosing the smallest odd multiple of a quarter-wavelength, other distances which depend on this distance for their dimensioning can be made short, resulting in a compact device.

Further favourable improvements can be obtained if, according to another preferred embodiment, the boundary surface for the second, greater depth of the body is arranged at a distance to the formed virtual cathode in the anode, which distance substantially corresponds to an odd multiple of the quarter-wavelength for the microwaves to be generated and is greater than a quarter-wavelength.

In addition, according to another preferred embodiment, the reflector can be disposed in the tube of the anode, which tube is at least partially transparent for electrons, transversely to the longitudinal direction of the tube at a distance from the virtual cathode formed in the anode, which distance substantially corresponds to an odd multiple of the quarter-wavelength for the microwaves to be generated.

According to yet another preferred embodiment, an electrically conductive stop wall is disposed on the outer side of the tube of the anode, which tube is at least partially transparent for electrons, transversely to the longitudinal direction of the tube at a distance which is substantially equal to an odd multiple of the quarter-wavelength for the microwaves to be generated and is greater than a quarter-wavelength from the boundary surface of the cathode for the first, lesser depth.

Advantageously, the boundary surface of the body for the lesser depth is configured with a somewhat increasing depth in that part of the boundary surface which lies at the radially greatest distance from the rotational axis of the body. This slight increase in the depression at the radially greatest distance contributes to the favourable realization of distances specified for the device, with respect to multiples of odd quarter-wavelengths.

A suitable reflector disposed adjacent to the anode comprises one or more electrically conductive surfaces for partially filling a cross section of the tubular anode. It is especially proposed that the electrically conductive surfaces of the reflector are constituted by metal strips. By virtue of the proposed configuration of the reflector, which can be structurally simple, a reflector with suitable balance between reflected and transmitted microwaves is produced. According to a proposed embodiment, the reflector is here configured with two opposite circle sectors forming electrically conductive surfaces. According to another embodiment, the reflector is configured as a central strip forming an electrically conductive surface. According to a further proposed embodiment, the reflector is configured with two strip sections separated in the centre of the reflector and forming an electrically conductive surface.

In an expedient embodiment, the electrically conductive body of the cathode is proposed to consist substantially of aluminium. The proposed material has the advantage of low weight and is relatively easy to machine, for example by turning.

For feeding of the cathode of the device, a high-voltage generator is expediently connected to the transmission conductor of the cathode. In addition, the wave guide for discharge of the microwave radiation is connected to an aerial. The aerial, it is proposed, can be a horn aerial.

The invention will be described in greater detail below in exemplified form with reference to the appended drawings, in which:

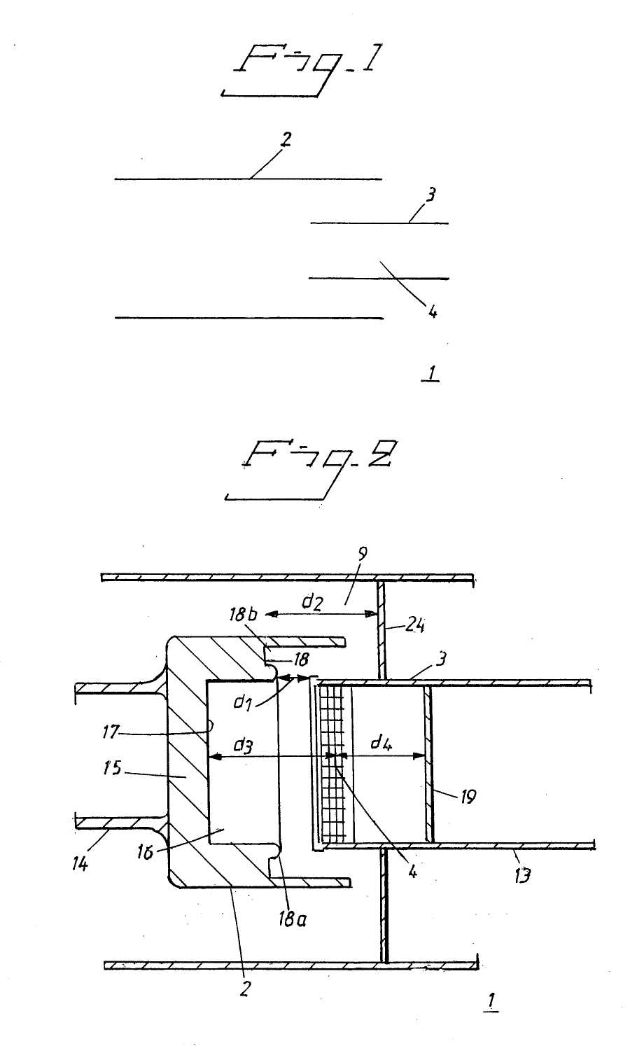

FIG. 1 shows schematically an example of a known coaxial virtual cathode oscillator forming part of a device for the generation of microwaves,

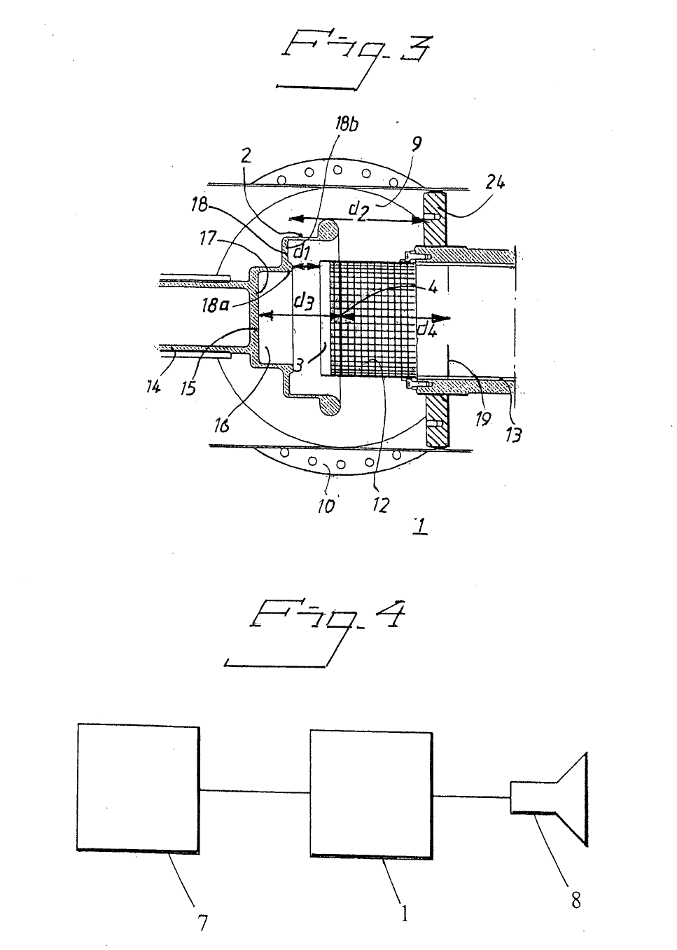

FIG. 2 shows schematically in sectional view an example of a coaxial virtual cathode oscillator according to the invention, forming part of a device for the generation of microwaves,

FIG. 3 shows a more detailed example in sectional view of a coaxial virtual cathode oscillator according to the invention, forming part of a device for the generation of microwaves,

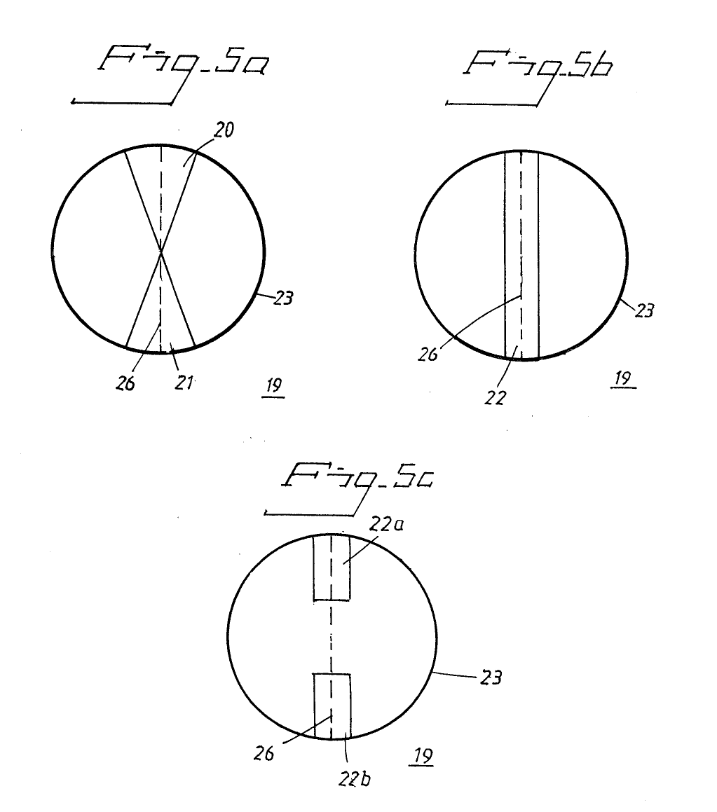

FIG. 4 shows schematically in block form a complete device for the generation of microwaves, comprising a coaxial virtual cathode oscillator according to the invention,

FIGS. 5a, 5b and 5c show schematically three examples of the configuration of a reflector which can form part of the coaxial virtual cathode oscillator shown in FIG. 2 or 3.

The known coaxial virtual cathode oscillator 1 which is shown in highly schematic representation in FIG. 1 comprises a cathode 2 in the form of an outer cylindrical tube and an anode 3 in the form of an inner cylindrical tube. The cathode oscillator is of a very simple geometric design and is based on the fact that a so-called virtual cathode 4 is formed inside the anode under certain conditions.

FIG. 2 shows somewhat less schematically in longitudinal cross section a modification of the known coaxial virtual cathode oscillator for improving the efficiency and enhancing the peak power. According to this embodiment, the cathode 2 is provided with a rotationally symmetric body 15 having a cavity 16 and the shape of the body can be most closely likened to the shape of a cup. The cavity 16 is configured such that it has a greater depth in the central parts of the body having a boundary surface 17, and a lesser depth in the outermost part (viewed radially from the centre of the body) having a boundary surface 18. The boundary surface 18 can in turn be divided into an inner part 18a of somewhat lower depth than an outer part 18b.

A conductive structure in the form of a reflector 19 is disposed in the interior of the anode. FIGS. 5a, 5b and 5c show three examples of possible configurations of the reflector 19. The reflectors comprise electrically conductive surfaces, which partially fill the cross section shaped by the tubular interior of the anode 3. According to the example in FIG. 5a, the conductive surfaces form two diagonally opposing circle sectors 20, 21, symmetrically centred with respect to a circle diameter 26. In FIG. 5b, the electrically conductive surface is constituted by a band 22, which is symmetrically centred with respect to the circle diameter 26. In FIG. 5c, the electrically conductive surface is constituted by two band sections 22a and 22b, which are symmetrically centred with respect to the circle diameter 26 and are separated from each other in the central part of the surrounding circle 23. In FIGS. 5a and 5b, the circle diameter 26 is marked by means of a dashed line. The circle 23 surrounding the conductive surfaces can be regarded as a mount for the conductive surfaces. Alternatively, the circle can symbolize the inner circumference of the tubular anode 3, in which the conductive surfaces can be directly fastened in the cathode tube.

On the outer side of the tubular anode 3, there is disposed a stop wall 24 consisting of an electrically conductive material, such as aluminium or copper.

In the figure there are four different distances, d₁-d₄, marked as follows:

d₁ marks the distance between the boundary surface 18a and the closure of the anode against the cathode,

d₂ marks the distance between the stop wall 24 and the boundary surface 18b,

d₃ marks the distance between the boundary surface 17 and the virtual cathode 4 which is formed in the anode 3, and

d₄ marks the distance between the virtual cathode 4 and the reflector 19 disposed in the interior of the tubular anode.

The distances d₁ to d₄ are advantageously chosen as follows:

d₁=λ*n/4, where n=1, 3, 5,

d₂=λ*n/4, where n=3, 5,7,

d₃=λ*n/4, where n=3, 5, 7

d₄=λ*n/4, where n=1, 3, 5,

with the secondary condition that d₂ and d₃>d₁.

The coaxial virtual cathode oscillator 1 can form part of a device for the generation of microwaves shown in FIG. 4 and comprising a high-voltage generator 7 connected to the input of the cathode oscillator and an aerial 8 connected to the output of the cathode oscillator. The aerial can be a horn aerial.

The cathode oscillator with peripheral arrangements is now shown and described in greater detail with reference to FIG. 3, both as regards configuration and working. Reference symbols having correspondence in previously described figures have been denoted with the same reference symbols in FIG. 3. According to FIG. 3, the anode 3 and cathode 2 are disposed in a vacuum chamber 9 to which there is a connection 10 for a vacuum pump (not shown). The anode 3 is provided with a grid 12, which is in part transparent for free, electrically charged particles. The anode 3 passes into an outbound wave guide 13, whilst the cathode 2 is fed via a transmission conductor 14.

The design of the cathode oscillator is based on the fact that a so-called virtual cathode is formed under certain conditions. When a voltage pulse with negative potential is applied via the transmission conductor 14 to the cathode 2, a highly electrical field is created between the cathode 2 and the anode 3. This results in electrons being field-emitted from the cathode material. The electrons are subsequently accelerated towards the anode structure and the majority of the electrons will also pass through the anode and begin to be retarded. If certain conditions are met, a virtual cathode 4 will be formed inside the anode structure. Owing to the fact that the process is strongly non-linear, phenomena occur which result in the generation of microwave radiation. The more detailed preconditions for the microwave generation are not described here, since this belongs to the sphere of competence of a person skilled in the art. Under the right preconditions, very high power is briefly generated in the order of magnitude, typically, of 50-100 ns, before short-circuiting occurs. Generated microwaves leave the anode of the cathode oscillator via the wave guide 13 connected to the anode, which has substantially the same radius as the anode 3. By configuring the body 15 with a cavity 16 and boundary surfaces 17, 18 of varying depth in interaction with the anode 3, introducing the reflector 19 and possibly the stop wall and, as far as possible, applying the above-specified distance measurements with respect to d₁-d₄, high-power pulses can be generated with substantially improved efficiency and peak power.

The invention is not limited to the embodiments shown above by way of example, but can be subjected to modifications within the scope of the following patent claims.

1. Device for the generation of microwaves. comprising a virtual cathode oscillator in coaxial construction having an outer substantially cylindrical tube constituting a cathode and connected to a transmission conductor for feeding the cathode with voltage pulses, as well as an inner substantially cylindrical tube, at least partially transparent for electrons, constituting an anode and connected to a wave guide for the discharge of microwave radiation generated by the formation of a virtual cathode inside a region enclosed by the anode, wherein an electrically conductive structure in the form of a reflector is disposed adjacent to the anode, and wherein the cathode comprises a substantially rotationally symmetric, electrically conductive body having a cavity, characterized in that the cavity in the body of the cathode is configured with a first, lesser depth to that boundary surface of the body which is directly in front of the peripheral part of the closure of the anode against the cathode, and a second, greater depth to that boundary surface of the body which is directly in front of the central part of the closure of the anode against the cathode.

2. Device according to Patent Claim I, characterized in that the closure of the device against the cathode is disposed at a distance to the boundary surface for the first, lesser depth of the body, which distance is substantially equal to an odd multiple of the quarter-wavelength for the microwaves to be generated.

3. Device according to Patent claim 2, characterized in that the closure of the anode against the cathode is disposed at a distance to the boundary surface for the first, lesser depth of the body, which distance is substantially equal to a quarter-wavelength for the microwaves to be generated.

4. Device according to claim 1, characterized in that the boundary surface for the second, greater depth of the body is arranged at a distance to the formed virtual cathode in the anode, which distance substantially corresponds to an odd multiple of the quarter-wavelength for the microwaves to be generated and is greater than a quarter-wavelength.

5. Device according to claim 1, characterized in that the reflector is disposed in the tube of the anode, which tube is at least partially transparent for electrons, transversely to the longitudinal direction of the tube at a distance from the virtual cathode formed in the anode, which distance substantially corresponds to an odd multiple of the quarter-wavelength for the microwaves to be generated.

6. Device according to claim 1, characterized in that an electrically conductive stop wall is disposed on the outer side of the tube of the anode, which tube is at least partially transparent for electrons, transversely to the longitudinal direction of the tube at a distance which is substantially equal to an odd multiple of the quarter-wavelength for the microwaves to be generated and is greater than a quarter-wavelength from the boundary surface of the cathode for the first, lesser depth.

7. Device according to claim 1, characterized in that the boundary surface of the body for the lesser depth is configured with a somewhat increasing depth in that part of the boundary surface which lies at the radially greatest distance from the rotational axis of the body.

8. Device according to claim 1, characterized in that the reflector disposed adjacent to the anode comprises one or more electrically conductive surfaces for partially filling a cross section of the tubular anode.

9. Device according to claim 8, characterized in that the electrically conductive surfaces of the reflector are constituted by metal strips.

10. Device according to claim 8, characterized in that the reflector is here configured with two opposite circle sectors forming electrically conductive surfaces.

11. Device according to claim 8, characterized in that the reflector is configured as a central strip forming an electrically conductive surface.

12. Device according to claim 8, characterized in that the reflector is configured with two strip sections separated in the centre of the reflector and forming an electrically conductive surface.

13. Device according to claim 1, characterized in that the electrically conductive body of the cathode consists substantially of aluminium.

14. Device according to claim 1, characterized in that the transmission conductor for feeding of the cathode is connected to a high-voltage generator.

15. Device according to claim 1, characterized in that the wave guide for discharge of the microwave radiation is connected to an aerial.

16. Device according to claim 15, characterized in that the aerial is a horn aerial.

17. Device according to claim 2, characterized in that the boundary surface for the second, greater depth of the body is arranged at a distance to the formed virtual cathode in the anode, which distance substantially corresponds to an odd multiple of the quarter-wavelength for the microwaves to be generated and is greater than a quarter-wavelength.

18. Device according to claim 3, characterized in that the boundary surface for the second, greater depth of the body is arranged at a distance to the formed virtual cathode in the anode, which distance substantially corresponds to an odd multiple of the quarter-wavelength for the microwaves to be generated and is greater than a quarter-wavelength.

19. Device according to claim 4, characterized in that the boundary surface for the second, greater depth of the body is arranged at a distance to the formed virtual cathode in the anode, which distance substantially corresponds to an odd multiple of the quarter-wavelength for the microwaves to be generated and is greater than a quarter-wavelength.

20. Device according to claim 2, characterized in that the reflector is disposed in the tube of the anode, which tube is at least partially transparent for electrons, transversely to the longitudinal direction of the tube at a distance from the virtual cathode formed in the anode, which distance substantially corresponds to an odd multiple of the quarter-wavelength for the microwaves to be generated.
